(19) United States
(12) Patent Application Publication
(10) Pub. No.: US 2019/0243674 A1
(43) Pub. Date: Aug. 8, 2019

(54) SYSTEM AND METHOD FOR ENTITY MANAGEMENT

(71) Applicant: Nutanix, Inc., San Jose, CA (US)

(72) Inventors: Raghu Prasad Rapole, Telangana (IN); Rahul Paul, Bangalore (IN); Raja Prathyush Kumar Thota, Bangalore (IN)

(21) Appl. No.: 15/891,590

(22) Filed: Feb. 8, 2018

(51) Int. Cl. G06F 9/455; G06F 9/50; H04L 29/08

(52) U.S. Cl. CPC G06F 9/45558; G06F 9/5077; G06F 2009/45595; G06F 2009/45562; H04L 67/1097

(57) ABSTRACT

A system and method include receiving, by an entity management system of a virtual computing system, a user request for performing an operation on an entity in a mixed hypervisor cluster of the virtual computing system and accessing, by the entity management system, a hypervisor library for retrieving hypervisor resources of a particular hypervisor type associated with the entity for performing the operation on the entity. The entity management system is configured to perform the operation on multiple hypervisor types. The system and method also include fulfilling, by the entity management system, the user request by performing the operation on the entity using the hypervisor resources.

### BACKGROUND

The following description is provided to assist the understanding of the reader. None of the information provided or references cited is admitted to be prior art.

Virtual computing systems are widely used in a variety of applications. Virtual computing systems include one or more host machines running one or more virtual machines concurrently. The virtual machines utilize the hardware resources of the underlying host machines. Each virtual machine may be configured to run an instance of an operating system. Modern virtual computing systems allow several operating systems and several software applications to be safely run at the same time on the virtual machines of a single host machine, thereby increasing resource utilization and performance efficiency. However, the present day virtual computing systems have limitations due to their configuration and the way they operate.

### SUMMARY

In accordance with at least some aspects of the present disclosure, a method is disclosed. The method includes receiving, by an entity management system of a virtual computing system, a user request for performing an operation on an entity in a mixed hypervisor cluster of the virtual computing system and accessing, by the entity management system, a hypervisor library for retrieving hypervisor resources of a particular hypervisor type associated with the entity for performing the operation on the entity. The entity management system is configured to perform the operation on multiple hypervisor types. The method also includes fulfilling, by the entity management system, the user request by performing the operation on the entity using the hypervisor resources.

In accordance with some other aspects of the present disclosure, a system is disclosed. The system includes an entity management system in a mixed hypervisor cluster of a virtual computing system having a database configured to store a configuration entry of an entity within the mixed hypervisor cluster and a processing unit. The processing unit is configured to receive a user request to perform an operation on the entity and access a hypervisor library to retrieve hypervisor resources of a particular hypervisor type associated with the entity to perform the operation on the entity. The entity management system is configured to perform the operation on multiple hypervisor types. The processing unit is also configured to fulfill the user request by performing the operation on the entity using the hypervisor resources.

In accordance with yet other embodiments of the present disclosure, a non-transitory computer readable media is disclosed. The non-transitory computer readable media includes computer-executable instructions that, when executed by a processor of an entity management system of a virtual computing system, cause the entity management system to perform a process. The process includes receiving a user request for performing an operation on an entity in a mixed hypervisor cluster of the virtual computing system and accessing a hypervisor library for retrieving hypervisor resources of a particular hypervisor type associated with the entity for performing the operation on the entity. The entity management system is configured to perform the operation on multiple hypervisor types. The process further includes fulfilling the user request by performing the operation on the entity using the hypervisor resources.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 is a block diagram of a virtual computing system, in accordance with some embodiments of the present disclosure.

FIG. 2A is another block diagram of the virtual computing system of FIG. 1 showing an entity management system, in accordance with some embodiments of the present disclosure.

FIG. 2B is yet another block diagram of the virtual computing system of FIG. 1 showing the entity management system, in accordance with some embodiments of the present disclosure.

FIG. 3 is a block diagram of the entity management system of FIGS. 2A and 2B, in accordance with some embodiments of the present disclosure.

FIG. 4 is an example flowchart outlining operations for creating virtual machines with the entity management system of FIGS. 2A and 2B, in accordance with some embodiments of the present disclosure.

FIG. 5 is an example flowchart outlining operations for managing virtual machines with the entity management system of FIGS. 2A and 2B, in accordance with some embodiments of the present disclosure.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

The present disclosure is generally directed to a virtual computing system having a plurality of clusters, with each cluster having a plurality of nodes. Each of the plurality of nodes includes one or more virtual machines managed by an instance of a hypervisor. A variety of management and non-management related operations may be performed on the virtual machine. For example, new instances of virtual machines may be created on one or more modes, existing instances of virtual machines may be deleted or updated, etc. Further, each virtual machine is associated with a variety of configuration parameters associated therewith that allow those virtual machines to perform their intended functions. The configuration parameters of the one or more virtual machines may include information such as identity information (e.g., name, universally unique identifier, etc.), number of processing units (e.g., virtual central processing units), amount of memory, location of data and metadata, network settings, type of hypervisor, etc. Furthermore, each virtual machine is specifically configured to run on the underlying hypervisor type.

Typically, all nodes within a cluster of the virtual computing system operate on the same hypervisor type. For example, in some embodiments, all hypervisors within a cluster may be of the type ESXi from VMware. In other embodiments, all hypervisors within the cluster may be of the type AHV from Nutanix, Inc. Occasionally, the hypervisor on one or more nodes within the cluster may be converted from a first type to a second type. Thus, during hypervisor conversion, some hypervisors may be of the first type, while others may be of the second type. Such clusters are called mixed hypervisor clusters. Since the operation of the underlying virtual machines is dependent upon the type of hypervisor on which those virtual machines are running, the hypervisor type needs to be known in order to perform operations on those virtual machines.

When all the hypervisors in the cluster are of the same type, the component performing operations on the virtual machines may assume that all virtual machines are running the hypervisor type that other nodes in the cluster are running. Virtual machine management in such cases is not particularly problematic. However, in mixed hypervisor clusters, the component performing operations on the virtual machines must know the hypervisor type of the virtual machines before performing any operations on those virtual machines. The component, therefore, either needs to be reconfigured to first determine the hypervisor type of a virtual machine before performing operations on that virtual machine, or risk the possibility that the operations will not be performed or will be performed incorrectly.

Reconfiguring the component not only increases the complexity of the management component, it is expensive. Further, since the reconfiguration is likely only needed during periods of hypervisor conversion, reconfiguring the component simply for the hypervisor conversion phase is not practical. Thus, a technical problem currently exists of properly managing virtual machines in a mixed hypervisor cluster.

The present disclosure provides solutions. For example, the present disclosure provides an entity management system that allows virtual machine management regardless of the underlying hypervisor type. The entity management system is configured to receive user requests for virtual machine management on a particular virtual machine, determine the type of hypervisor of that virtual machine, and perform the virtual machine management operations in accordance with the hypervisor type of that virtual machine. The entity management system is configured to be operative on multiple hypervisor types.

Thus, the present disclosure provides an easy, convenient, and effective mechanism for performing virtual machine management in a mixed hypervisor cluster without having to reconfigure other components.

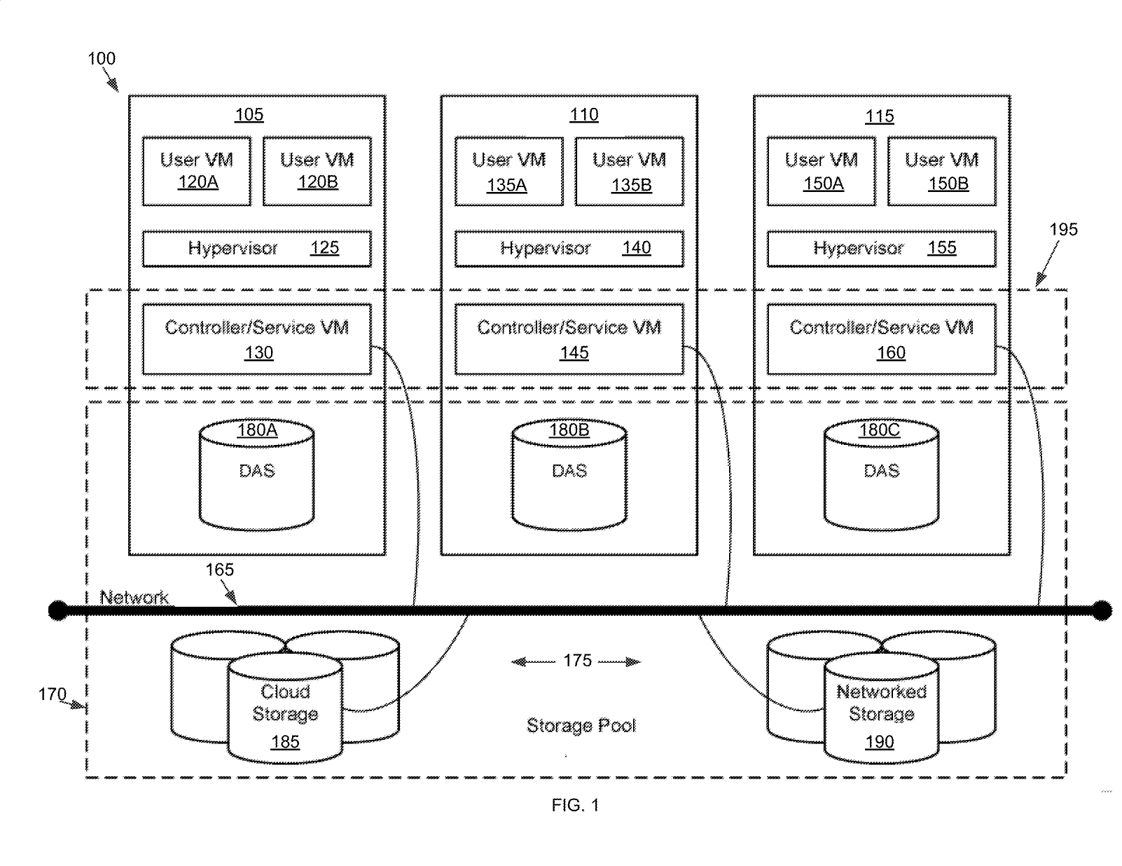

Referring now to FIG. 1, a virtual computing system 100 is shown, in accordance with some embodiments of the present disclosure. The virtual computing system 100 includes a plurality of nodes, such as a first node 105, a second node 110, and a third node 115. Each of the first node 105, the second node 110, and the third node 115 may also be referred to as a “host” or “host machine.” The first node 105 includes user virtual machines (“user VMs”) 120A and 120B (collectively referred to herein as “user VMs 120”), a hypervisor 125 configured to create and run the user VMs, and a controller/service VM 130 configured to manage, route, and otherwise handle workflow requests between the various nodes of the virtual computing system 100. Similarly, the second node 110 includes user VMs 135A and 135B (collectively referred to herein as “user VMs 135”), a hypervisor 140, and a controller/service VM 145, and the third node 115 includes user VMs 150A and 150B (collectively referred to herein as “user VMs 150”), a hypervisor 155, and a controller/service VM 160. The controller/service VM 130, the controller/service VM 145, and the controller/service VM 160 are all connected to a network 165 to facilitate communication between the first node 105, the second node 110, and the third node 115. Although not shown, in some embodiments, the hypervisor 125, the hypervisor 140, and the hypervisor 155 may also be connected to the network 165.

The virtual computing system 100 also includes a storage pool 170. The storage pool 170 may include network-attached storage 175 and direct-attached storage 180A, 180B, and 180C. The network-attached storage 175 is accessible via the network 165 and, in some embodiments, may include cloud storage 185, as well as local storage area network 190. In contrast to the network-attached storage 175, which is accessible via the network 165, the direct-attached storage 180A, 180B, and 180C includes storage components that are provided within each of the first node 105, the second node 110, and the third node 115, respectively, such that each of the first, second, and third nodes may access its respective direct-attached storage without having to access the network 165.

It is to be understood that only certain components of the virtual computing system 100 are shown in FIG. 1. Nevertheless, several other components that are needed or desired in the virtual computing system to perform the functions described herein are contemplated and considered within the scope of the present disclosure. Some additional features of the virtual computing system 100 are described in U.S. Pat. No. 8,601,473, the entirety of which is incorporated by reference herein.

Although three of the plurality of nodes (e.g., the first node 105, the second node 110, and the third node 115) are shown in the virtual computing system 100, in other embodiments, greater than or fewer than three nodes may be used. Likewise, although only two of the user VMs (e.g., the user VMs 120, the user VMs 135, and the user VMs 150) are shown on each of the respective first node 105, the second node 110, and the third node 115, in other embodiments, the number of the user VMs on each of the first, second, and third nodes may vary to include either a single user VM or more than two user VMs. Further, the first node 105, the second node 110, and the third node 115 need not always have the same number of the user VMs (e.g., the user VMs 120, the user VMs 135, and the user VMs 150).

In some embodiments, each of the first node 105, the second node 110, and the third node 115 may be a hardware device, such as a server. For example, in some embodiments, one or more of the first node 105, the second node 110, and the third node 115 may be an NX-1000 server, NX-3000 server, NX-6000 server, NX-8000 server, etc. provided by Nutanix, Inc. or server computers from Dell, Inc., Lenovo Group Ltd. or Lenovo PC International, Cisco Systems, Inc., etc. In other embodiments, one or more of the first node 105, the second node 110, or the third node 115 may be another type of hardware device, such as a personal computer, an input/output or peripheral unit such as a printer, or any type of device that is suitable for use as a node within the virtual computing system 100. In some embodiments, the virtual computing system 100 may be part of a data center.

Each of the first node 105, the second node 110, and the third node 115 may also be configured to communicate and share resources with each other via the network 165. For example, in some embodiments, the first node 105, the second node 110, and the third node 115 may communicate and share resources with each other via the controller/service VM 130, the controller/service VM 145, and the controller/service VM 160, and/or the hypervisor 125, the hypervisor 140, and the hypervisor 155. One or more of the first node 105, the second node 110, and the third node 115 may be organized in a variety of network topologies.

Also, although not shown, one or more of the first node 105, the second node 110, and the third node 115 may include one or more processing units configured to execute instructions. The instructions may be carried out by a special purpose computer, logic circuits, or hardware circuits of the first node 105, the second node 110, and the third node 115. The processing units may be implemented in hardware, firmware, software, or any combination thereof. The term “execution” is, for example, the process of running an application or the carrying out of the operation called for by an instruction. The instructions may be written using one or more programming language, scripting language, assembly language, etc. The processing units, thus, execute an instruction, meaning that they perform the operations called for by that instruction.

The processing units may be operably coupled to the storage pool 170, as well as with other elements of the first node 105, the second node 110, and the third node 115 to receive, send, and process information, and to control the operations of the underlying first, second, or third node. The processing units may retrieve a set of instructions from the storage pool 170, such as, from a permanent memory device like a read only memory (“ROM”) device and copy the instructions in an executable form to a temporary memory device that is generally some form of random access memory (“RAM”). The ROM and RAM may both be part of the storage pool 170, or in some embodiments, may be separately provisioned from the storage pool. Further, the processing units may include a single stand-alone processing unit, or a plurality of processing units that use the same or different processing technology.

With respect to the storage pool 170 and particularly with respect to the direct-attached storage 180A, 180B, and 180C, each of the direct-attached storage may include a variety of types of memory devices. For example, in some embodiments, one or more of the direct-attached storage 180A, 180B, and 180C may include, but is not limited to, any type of RAM, ROM, flash memory, magnetic storage devices (e.g., hard disk, floppy disk, magnetic strips, etc.), optical disks (e.g., compact disk (“CD”), digital versatile disk (“DVD”), etc.), smart cards, solid state devices, etc. Likewise, the network-attached storage 175 may include any of a variety of network accessible storage (e.g., the cloud storage 185, the local storage area network 190, etc.) that is suitable for use within the virtual computing system 100 and accessible via the network 165. The storage pool 170, including the network-attached storage 175 and the direct-attached storage 180A, 180B, and 180C, may together form a distributed storage system configured to be accessed by each of the first node 105, the second node 110, and the third node 115 via the network 165, the controller/service VM 130, the controller/service VM 145, the controller/service VM 160, and/or the hypervisor 125, the hypervisor 140, and the hypervisor 155. In some embodiments, the various storage components in the storage pool 170 may be configured as virtual disks for access by the user VMs 120, the user VMs 135, and the user VMs 150.

Each of the user VMs 120, the user VMs 135, and the user VMs 150 is a software-based implementation of a computing machine in the virtual computing system 100. The user VMs 120, the user VMs 135, and the user VMs 150 emulate the functionality of a physical computer. Specifically, the hardware resources, such as processing unit, memory, storage, etc., of the underlying computer (e.g., the first node 105, the second node 110, and the third node 115) are virtualized or transformed by the respective hypervisor 125, the hypervisor 140, and the hypervisor 155, into the underlying support for each of the user VMs 120, the user VMs 135, and the user VMs 150 that may run its own operating system and applications on the underlying physical resources just like a real computer. By encapsulating an entire machine, including CPU, memory, operating system, storage devices, and network devices, the user VMs 120, the user VMs 135, and the user VMs 150 are compatible with most standard operating systems (e.g. Windows, Linux, etc.), applications, and device drivers. Thus, each of the hypervisor 125, the hypervisor 140, and the hypervisor 155 is a virtual machine monitor that allows a single physical server computer (e.g., the first node 105, the second node 110, third node 115) to run multiple instances of the user VMs 120, the user VMs 135, and the user VMs 150, with each user VM sharing the resources of that one physical server computer, potentially across multiple environments. By running the user VMs 120, the user VMs 135, and the user VMs 150 on each of the first node 105, the second node 110, and the third node 115, respectively, multiple workloads and multiple operating systems may be run on a single piece of underlying hardware computer (e.g., the first node, the second node, and the third node) to increase resource utilization and manage workflow.

The user VMs 120, the user VMs 135, and the user VMs 150 are controlled and managed by their respective instance of the controller/service VM 130, the controller/service VM 145, and the controller/service VM 160. The controller/service VM 130, the controller/service VM 145, and the controller/service VM 160 are configured to communicate with each other via the network 165 to form a distributed system 195. Each of the controller/service VM 130, the controller/service VM 145, and the controller/service VM 160 may also include a local management system (e.g., Prism Element from Nutanix, Inc.) configured to manage various tasks and operations within the virtual computing system 100. For example, in some embodiments, the local management system may perform various management related tasks on the user VMs 120, the user VMs 135, and the user VMs 150, as explained in greater detail below.

The hypervisor 125, the hypervisor 140, and the hypervisor 155 of the first node 105, the second node 110, and the third node 115, respectively, may be configured to run virtualization software, such as, ESXi from VMWare, AHV from Nutanix, Inc., XenServer from Citrix Systems, Inc., etc. The virtualization software on the hypervisor 125, the hypervisor 140, and the hypervisor 155 may be configured for running the user VMs 120, the user VMs 135, and the user VMs 150, respectively, and for managing the interactions between those user VMs and the underlying hardware of the first node 105, the second node 110, and the third node 115. Each of the controller/service VM 130, the controller/service VM 145, the controller/service VM 160, the hypervisor 125, the hypervisor 140, and the hypervisor 155 may be configured as suitable for use within the virtual computing system 100.

The network 165 may include any of a variety of wired or wireless network channels that may be suitable for use within the virtual computing system 100. For example, in some embodiments, the network 165 may include wired connections, such as an Ethernet connection, one or more twisted pair wires, coaxial cables, fiber optic cables, etc. In other embodiments, the network 165 may include wireless connections, such as microwaves, infrared waves, radio waves, spread spectrum technologies, satellites, etc. The network 165 may also be configured to communicate with another device using cellular networks, local area networks, wide area networks, the Internet, etc. In some embodiments, the network 165 may include a combination of wired and wireless communications.

Referring still to FIG. 1, in some embodiments, one of the first node 105, the second node 110, or the third node 115 may be configured as a leader node. The leader node may be configured to monitor and handle requests from other nodes in the virtual computing system 100. For example, a particular user VM (e.g., the user VMs 120, or the user VMs 135) may direct an input/output request to the controller/service VM (e.g., the controller/service VM 130, the controller/service VM 145, or the controller/service VM 160) on the underlying node (e.g., the first node 105, the second node 110, or the third node 115). Upon receiving the input/output request, that controller/service VM may direct the input/output request to the controller/service VM (e.g., one of the controller/service VM 130, the controller/service VM 145, or the controller/service VM 160) of the leader node. In some cases, the controller/service VM that receives the input/output request may itself be on the leader node, in which case, the controller/service VM does not transfer the request, but rather handles the request itself.

The controller/service VM of the leader node may fulfil the input/output request (and/or request another component within the virtual computing system 100 to fulfil that request). Upon fulfilling the input/output request, the controller/service VM of the leader node may send a response back to the controller/service VM of the node from which the request was received, which in turn may pass the response to the user VM that initiated the request. In a similar manner, the leader node may also be configured to receive and handle requests (e.g., user requests) from outside of the virtual computing system 100. If the leader node fails, another leader node may be designated.

Furthermore, one or more of the first node 105, the second node 110, and the third node 115 may be combined together to form a network cluster (also referred to herein as simply “cluster.”) Generally speaking, all of the nodes (e.g., the first node 105, the second node 110, and the third node 115) in the virtual computing system 100 may be divided into one or more clusters. One or more components of the storage pool 170 may be part of the cluster as well. For example, the virtual computing system 100 as shown in FIG. 1 may form one cluster in some embodiments. Multiple clusters may exist within a given virtual computing system (e.g., the virtual computing system 100). The user VMs 120, the user VMs 135, and the user VMs 150 that are part of a cluster are configured to share resources with each other. In some embodiments, multiple clusters may share resources with one another.

Additionally, in some embodiments, although not shown, the virtual computing system 100 includes a central management system (e.g., Prism Central from Nutanix, Inc.) that is configured to manage and control the operation of the various clusters in the virtual computing system. In some embodiments, the central management system may be configured to communicate with the local management systems on each of the controller/service VM 130, the controller/service VM 145, the controller/service VM 160 for controlling the various clusters. In other embodiments, the central management system may be configured to communicate with the controller/service VM (e.g., the controller/service VM 130, the controller/service VM 145, the controller/service VM 160) of the leader node.

Again, it is to be understood again that only certain components and features of the virtual computing system 100 are shown and described herein. Nevertheless, other components and features that may be needed or desired to perform the functions described herein are contemplated and considered within the scope of the present disclosure. It is also to be understood that the configuration of the various components of the virtual computing system 100 described above is only an example and is not intended to be limiting in any way. Rather, the configuration of those components may vary to perform the functions described herein.

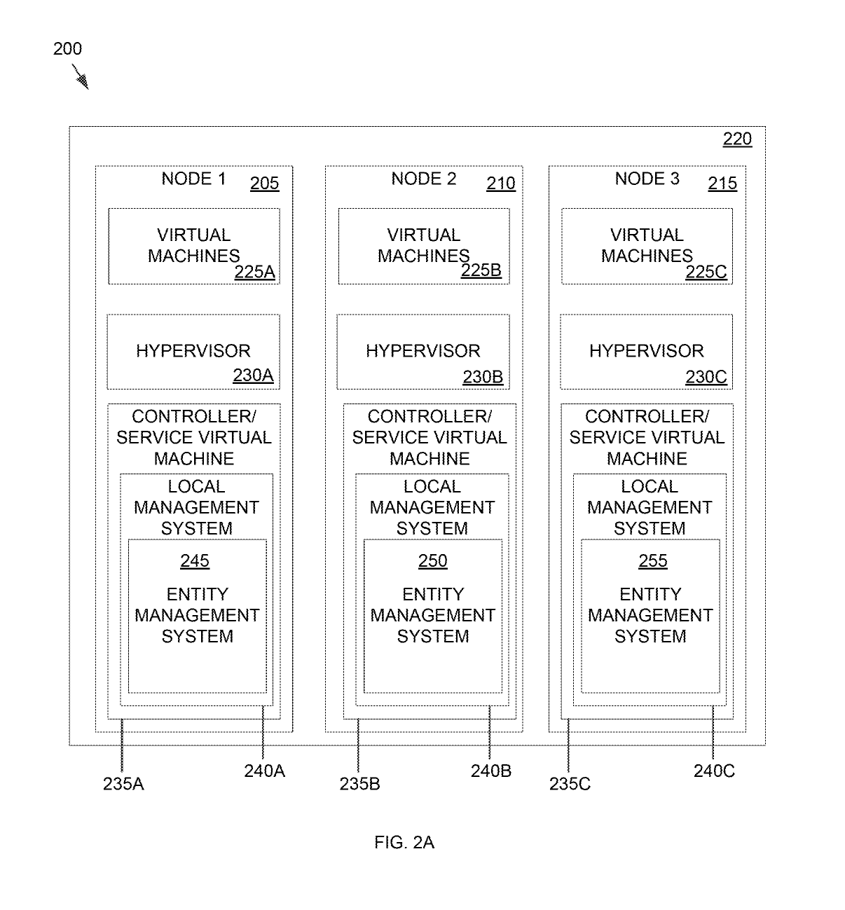

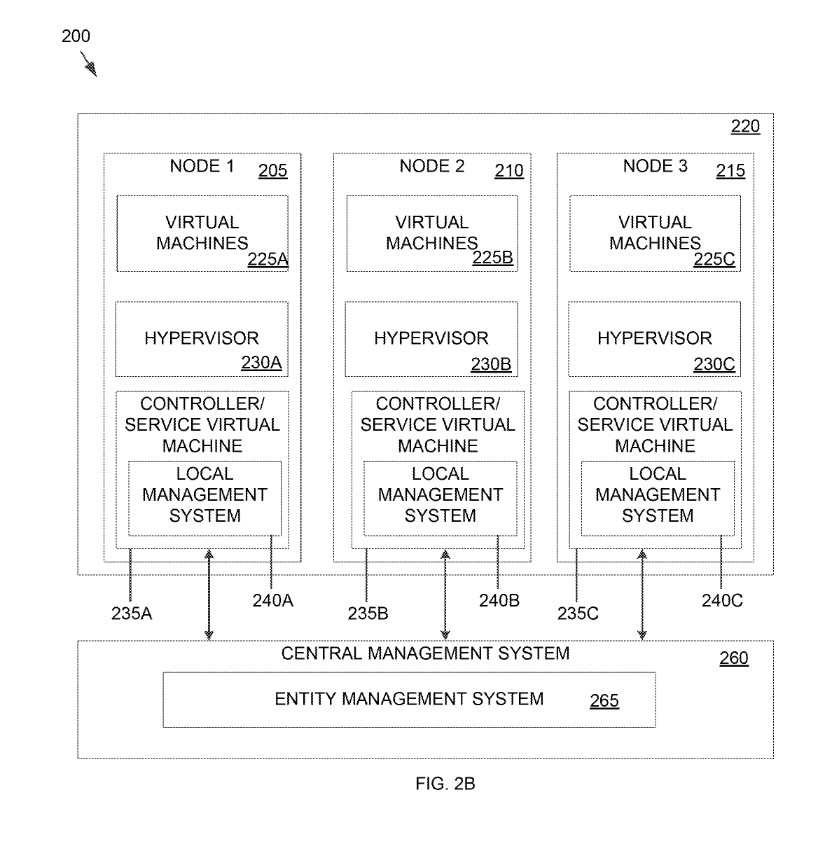

Turning to FIGS. 2A and 2B, another block diagram of a virtual computing system 200 is shown, in accordance with some embodiments of the present disclosure. The virtual computing system 200 is analogous to, albeit a simplified version, of the virtual computing system 100. Thus, although only some of the components have been shown in the virtual computing system 200, the virtual computing system is intended to include other components and features, as discussed above with respect to the virtual computing system 100. Referring to FIGS. 2A and 2B together, the virtual computing system 200 includes a first node 205, a second node 210, and a third node 215, all of which form part of a cluster 220. Although only three nodes (e.g., the first node 205, the second node 210, and the third node 215) have been shown in the cluster 220, the number of nodes may vary to be greater than or fewer than three.

The first node 205 includes virtual machines 225A, the second node 210 includes virtual machines 225B, and the third node 215 includes virtual machines 225C. Additionally, the first node 205 includes a hypervisor 230A and a controller/service virtual machine 235A. Similarly, the second node 210 includes a hypervisor 230B, and a controller/service virtual machine 235B, while the third node 215 includes a hypervisor 230C, and a controller/service virtual machine 235C. Further, each of the controller/service virtual machine 235A, controller/service virtual machine 235B, and controller/service virtual machine 235C respectively include a local management system 240A, a local management system 240B, and a local management system 240C. The local management system 240A, the local management system 240B, and the local management system 240C, in some embodiments, may be the Prism Element component from Nutanix, Inc., and may be configured to perform a variety of management tasks on the underlying node (e.g., the first node 205, the second node 210, and the third node 215, respectively).

Further, in some embodiments, the hypervisor 230A, the hypervisor 230B, and the hypervisor 230C may be of different types. For example, in some embodiments, one or more of the hypervisor 230A, the hypervisor 230B, and the hypervisor 230C may be of a first type and the remaining ones of those hypervisors may be of a second type. In some embodiments, the first type of hypervisor may be an ESXi type of hypervisor, while the second type of hypervisor may be of an AHV type of hypervisor, or vice-versa. In other embodiments, the first type and the second type of the hypervisor may be of any other type of hypervisor that is commonly used in virtual computing systems (e.g., the virtual computing system 200). By virtue of one or more of the hypervisor 230A, the hypervisor 230B, and the hypervisor 230C being of a type that is different from the type of the remaining hypervisors in the cluster 220, the cluster is a “mixed hypervisor” cluster.

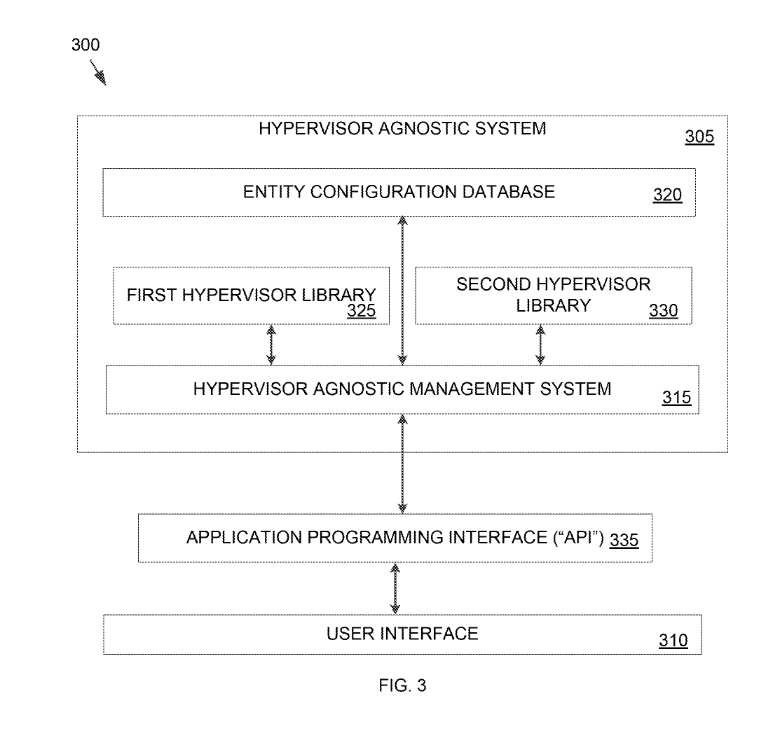

Referring now specifically to FIG. 2A, the local management system 240A, the local management system 240B, and the local management system 240C, respectively, include an entity management system 245, an entity management system 250, and an entity management system 255. The entity management system 245, the entity management system 250, and the entity management system 255 are each configured to perform a variety of entity management functions on the underlying node (e.g., the first node 205, the second node 210, and the third node 215, respectively). Specifically, the entity management system 245, the entity management system 250, and the entity management system 255 are configured to provide a hypervisor agnostic layer that is capable of performing entity management on the underlying node (e.g., the first node 205, the second node 210, and the third node 215, respectively) in a mixed hypervisor cluster (e.g., the cluster 220), as discussed in FIGS. 3-5 below.

In some embodiments and as shown in FIG. 2B, instead of being part of the local management system 240A, the local management system 240B, and the local management system 240C, the entity management system may be part of a central management system 260. Thus, the central management system 260 may include an entity management system 265. The central management system 260, in some embodiments, is the Prism Central component from Nutanix, Inc. and is configured to manage all of the clusters (e.g., including the cluster 220) within the virtual computing system 200. In some embodiments, the central management system 260 is configured to communicate with the local management system 240A, the local management system 240B, and the local management system 240C of the cluster 220 for managing the various components of that cluster. In other embodiments, the central management system 260 is configured to communicate with the local management system (e.g., the local management system 240A, the local management system 240B, or the local management system 240C) of the leader node. In other embodiments, one of the local management system 240A, the local management system 240B, and the local management system 240C may be designated as a leader of all the local management systems (which may possibly be situated on a node other than the leader node) and the central management system 260 may communicate with the leader local management system. Similarly, the central management system 260 may communicate with the local management systems of the nodes of the other clusters in the virtual computing system 200 for managing those clusters.

The entity management system 265 is analogous to each of the entity management system 245, the entity management system 250, and the entity management system 255 of FIG. 2A discussed above. Further, although each of the entity management system 245, the entity management system 250, and the entity management system 255 of FIG. 2A is shown as entirely being a part of the local management system 240A, the local management system 240B, and the local management system 240C, respectively, and the entity management system 265 of FIG. 2B is shown as entirely being a part of the central management system 260, in some embodiments, portions of those entity management systems may be part of the local management system and other portions may be part of the central management system. In other embodiments, an instance of the entity management system (e.g., the entity management system 245, the entity management system 250, and the entity management system 255, the entity management system 265) may be provided in both, the local management system (e.g., the local management system 240A, the local management system 240B, and the local management system 240C), as well as the central management system (e.g., the central management system 260). Thus, the entity management system 245, the entity management system 250, the entity management system 255, and the entity management system 265 may be configured in a variety of ways.

Further, each of the entity management system 245, the entity management system 250, the entity management system 255, and the entity management system 265 is associated with or includes a distributed entity configuration database (See FIG. 3 below). Thus, the local management system (e.g., the local management system 240A, the local management system 240B, and the local management system 240C) accesses the entity configuration database and determines various configuration related information of the virtual machines (e.g., the virtual machines 225A, the virtual machines 225B, and the virtual machines 225C) that reside on any node within the cluster (e.g., the cluster 220). In some embodiments and as noted above, one of the local management systems (e.g., the local management system 240A, the local management system 240B, and the local management system 240C) may be elected as a leader for performing the various operations, as discussed below, by fetching data from the entity configuration database.

Again, notwithstanding the components of the virtual computing system 200 shown and described herein, in other embodiments, the virtual computing system 200 is intended to include other components and features, as described above with respect to the virtual computing system 100.

Referring now to FIG. 3, a block diagram of an entity management system 300 is shown, in accordance with some embodiments of the present disclosure. The entity management system 300 includes a hypervisor agnostic system 305 that is configured to perform a variety of entity management operations in response to management commands received from a user via a user interface 310. An “entity” as used herein means clusters, nodes, virtual machines, virtual disks, software applications, and other hardware, software, storage, virtual clouds, and data center components that make up the virtual computing system 100 and the virtual computing system 200. Thus, the entity management system 300 is configured to perform a variety of management operations that are associated with the entity being managed. Example management operations may include creating an entity, deleting an entity, updating a feature of an entity, etc.

Simply for purposes of explanation, the disclosure below has been explained with respect to the management of a virtual machine, also referred to herein as virtual machine management. However, the present disclosure is also applicable to the management of other types of entities within the virtual computing system 100, 200. Operations associated with virtual machine management may include operations such as creation of a virtual machine, deletion of a virtual machine, updating a configuration (e.g., varying the amount of memory, number of processing units, location of data, etc.) of the virtual machine, changing network settings associated with the virtual machine, and adding, deleting, modifying any other feature or component associated with the virtual machine. Furthermore, although the present disclosure has been described in terms of “management” operations, the present disclosure is also applicable to performing non-management type operations (e.g., input/output requests) on the virtual machines and the other entities in the virtual computing system 100 and the virtual computing system 200.

A virtual machine (e.g., the virtual machines 225A, the virtual machines 225B, and the virtual machines 225C of FIGS. 2A and 2B) is specifically configured to be operable on a specific type of hypervisor. Thus, the virtual machine is said to be “hypervisor specific.” When the type of hypervisor is changed (e.g., the hypervisor is converted from a first hypervisor type to a second hypervisor type), the virtual machines associated with that hypervisor are reconfigured to be operative on the new hypervisor type. Thus, the virtual machines are operated based upon the underlying type of hypervisor. Each hypervisor type is associated with different sets of instructions, routines, protocols, applications, software programs, templates, configuration data, etc., collectively referred to herein as “hypervisor resources.” These hypervisor resources are used for running and/or managing the operation of the associated virtual machines. For example, a virtual machine running on an ESXi type of hypervisor is run and/or managed in accordance with and using the ESXi hypervisor resources. Similarly, a virtual machine running on an AHV type of hypervisor is run and/or managed in accordance with and using AHV hypervisor resources.

When all of the nodes in a cluster are running on the same type of hypervisor (e.g., either ESXi, either AHV, etc.), then the same hypervisor resources are used for running and/or managing all virtual machines in that cluster, and components performing virtual machine management may easily perform virtual machine management without having specific knowledge of the type of the underlying hypervisor. Conventional virtual machine management systems are configured for such single hypervisor type configurations. However, in a mixed hypervisor situation where some nodes in a cluster are running on a first type of hypervisor and other nodes are running on a second type of hypervisor, virtual machine management is challenging. The components performing virtual machine management need to identify the proper hypervisor resources to apply before performing virtual machine management. Conventional virtual machine management systems are not configured for mixed hypervisor situations, and are therefore, unable to perform virtual machine management accurately and effectively in such situations.

The entity management system 300 provides a mechanism to easily and effectively perform virtual machine management in a mixed hypervisor configuration. Specifically, the entity management system 300 provides a hypervisor agnostic layer such that components may perform virtual machine management without needing to know the hypervisor type of a particular virtual machine and without needing to undergo any complex modification or reprogramming.

The entity management system 300 includes the hypervisor agnostic system 305 that is configured to facilitate virtual machine management regardless of the type of hypervisor on which a particular virtual machine is running. The hypervisor agnostic system 305 includes a hypervisor agnostic management system 315 that is configured to receive a virtual machine management command via the user interface 310, determine the type of hypervisor associated with the virtual machine on which the virtual machine management command is to be applied, and perform or cause to perform the virtual machine management operation identified in the virtual machine management command on that virtual machine based upon the type of hypervisor. The hypervisor agnostic management system 315 may also be configured to send one or more notifications to a user device on which the user interface 310 is displayed in response to a previously received virtual machine management command.

Although not shown, the hypervisor agnostic management system 315 may be configured as hardware, software, firmware, or a combination thereof. Specifically, the hypervisor agnostic management system 315 may include one or more processing units configured to execute instructions and one or more memory units to store those instructions and other conversion related data. In some embodiments, the hypervisor agnostic management system 315 may be connected to a storage pool (e.g., the storage pool 170) to receive, send, and process information, and to control the operations of the conversion. The instructions may be carried out by a special purpose computer, logic circuits, or hardware circuits of the hypervisor agnostic management system 315. The processing units may, thus, be implemented in hardware, firmware, software, or any combination thereof. The processing units execute an instruction, meaning that they perform the operations called for by that instruction. The processing units may retrieve a set of instructions from a memory (e.g., the storage pool 170 or any other memory in which such instructions may be stored). For example, in some embodiments, the processing units may retrieve the instructions from a permanent memory device like a read only memory (ROM) device and copy the instructions in an executable form to a temporary memory device that is generally some form of random access memory (RAM). The ROM and RAM may both be part of the storage pool (e.g., the storage pool 170), or in some embodiments, may be separately provisioned from the storage pool. Further, the processing units may include a single stand-alone processing unit, or a plurality of processing units that use the same or different processing technology. The instructions may be written using one or more programming language, scripting language, assembly language, etc.

The hypervisor agnostic management system 315 is in communication with an entity configuration database 320, a first hypervisor library 325, and a second hypervisor library 330. The entity configuration database 320 is configured to store a configuration entry of each entity within a particular node. For example, the entity configuration database 320 may be configured to store a configuration entry of each virtual machine within a particular cluster. The configuration entry of each virtual machine may include a variety of information associated with a particular virtual machine such as name of the virtual machine, a unique identifier associated with the virtual machine, the type of hypervisor that the virtual machine is configured to run on, a current operating state (e.g., normal, transient, etc.) of the virtual machine, network settings of the virtual machine, the identity of the node on which the virtual machine is located within the cluster, etc. Thus, configuration information pertaining to a particular virtual machine is stored in the entity configuration database 320.

In some embodiments, the entity configuration database 320 may be part of the storage pool (e.g., the storage pool 170 of FIG. 1) of the virtual computing system (e.g., the virtual computing system 100 of FIG. 1). Thus, the entity configuration database 320 may be part of the distributed storage system that may be accessed by all of the nodes (e.g., the first node 105, the second node 110, and the third node 115) within a particular cluster. In other embodiments, the entity configuration database 320 may be part of another database that is separated from the storage pool 170, but associated with the hypervisor agnostic system 305. The hypervisor agnostic management system 315 may use the entity configuration database 320 to determine the hypervisor type of a particular virtual machine on which virtual machine management is to be performed. For example, the hypervisor agnostic management system 315 may access the configuration entry of the virtual machine on which virtual machine management is to be performed. Since the configuration entry includes information about the type of hypervisor of the virtual machine, the hypervisor agnostic management system 315 determines the type of hypervisor by accessing the configuration entry.

In some embodiments, the hypervisor agnostic management system 315 also updates the configuration entries of the virtual machines when any changes to those virtual machines are made. For example, when a particular virtual machine which was previously operating on a first hypervisor type is reconfigured for operating on a second hypervisor type, the configuration entry of that virtual machine is updated in the entity configuration database 320 to reflect the second hypervisor type. In some embodiments, the hypervisor agnostic management system 315 may update the entity configuration database 320 itself. In other embodiments, the hypervisor agnostic management system 315 may request another designated component to update the entity configuration database 320.

Further, the hypervisor agnostic management system 315 may determine that the configuration entry of a particular virtual machine is to be updated by periodically polling all the virtual machines in the cluster, polling the hypervisors on the various nodes in the cluster, polling another component having knowledge of the updates, etc. In other embodiments, an updating service may be running on each node that publishes any updates to the underlying virtual machines. The hypervisor agnostic management system 315 may periodically access that publishing service to determine whether the virtual machines have been updated, and then update (or request to update) the configuration entry of the updated virtual machines in the entity configuration database 320.

The hypervisor agnostic management system 315 is also configured to access the first hypervisor library 325 and the second hypervisor library 330, which are configured to store the hypervisor resources of a first type of hypervisor and a second type of hypervisor, respectively. The first hypervisor library 325 and the second hypervisor library 330 are used to perform management operations on virtual machines, as discussed in greater detail below. Simply as an example and without intending to be limiting in any way, if the hypervisor agnostic management system 315 receives a request to power on a particular virtual machine, the hypervisor agnostic management system accesses the entity configuration database 320 to determine the hypervisor type of that particular virtual machine and then depending upon the hypervisor type, the hypervisor agnostic management system selects either the first hypervisor library 325 or the second hypervisor library 330 before (or along with) invoking a power operation for the particular virtual machine on the specific hypervisor type.

The first hypervisor library 325 and the second hypervisor library 330 are stored within the controller/service VM (e.g., the controller/service virtual machine 235A, controller/service virtual machine 235B, and controller/service virtual machine 235C of FIGS. 2A and 2B). In some embodiments, either or both of the first hypervisor library 325 and the second hypervisor library 330 may be stored in another component associated with the hypervisor agnostic management system 315. The first hypervisor library 325 and the second hypervisor library 330 may correspond to the type of hypervisors that are running on a particular cluster. For example, if a cluster is running ESXi and AHV types of hypervisors, the first hypervisor library 325 may be for the ESXi hypervisor and the second hypervisor library 330 may be for the AHV hypervisor.

Although only two hypervisor libraries (e.g., the first hypervisor library 325 and the second hypervisor library 330) are shown herein, in other embodiments, the number of libraries may correspond to the number of different types of hypervisors that are provided within a cluster that the entity management system 300 is managing.

Referring still to FIG. 3, users may access the hypervisor agnostic system 305 via the user interface 310 and an API 335. The users may access the user interface 310 via their personal devices such as laptops, desktops, tablets, other handheld or portable devices, and/or other types of computing devices that are designated to access the API 335. The API 335 is an interface that provides a set of routines, protocols, and tools to allow users to access the hypervisor agnostic system 305. In some embodiments, the API 335 is a representational state transfer (“REST”) type of API. In other embodiments, the API 335 may be any other type of web API (e.g., ASP.NET) built using any of a variety of technologies, such as Java, .Net, etc. Thus, the API 335 may be configured as any of a variety of types of APIs that are capable of accessing the hypervisor agnostic system 305 and routing requests between users and the user interface 310 and the hypervisor agnostic system.

In some embodiments, the API 335 may be configured to facilitate communication between the user interface 310 and the hypervisor agnostic system 305 via a hypertext transfer protocol (“HTTP”) or hypertext transfer protocol secure (“HTTPS”) type request. The API 335 may receive an HTTP/HTTPS request (generally referred to herein as a “user request”) from the user interface 310 displayed on a user device of the user and send an HTTP/HTTPS response back to that user via the user interface and the user device. In other embodiments, depending upon the type of the API 335, the API may be configured to facilitate communication with the users using other or additional types of communication protocols. Further, although not shown, the API 335 may be hosted on an API gateway, which may facilitate receiving user requests from multiple users and routing those requests to the hypervisor agnostic system 305.

The user interface 310 is used to receive a virtual machine management command from the user. In some embodiments, the virtual machine management command may be to perform one or more virtual machine management operations on one or more virtual machines in response to hypervisor conversion from a first hypervisor type to a second hypervisor type. In other embodiments, the virtual machine management command may be to perform other management and non-management related operations on the virtual machines. The user interface 310 may present one or more displays and options to the user that the user may interact with to send virtual machine management commands.

It is to be understood that only some components of the entity management system 300 are shown and described herein. Nevertheless, the entity management system 300 may include other components that are considered desirable or needed to perform the functions described herein. Such components are contemplated and considered within the scope of the present disclosure.

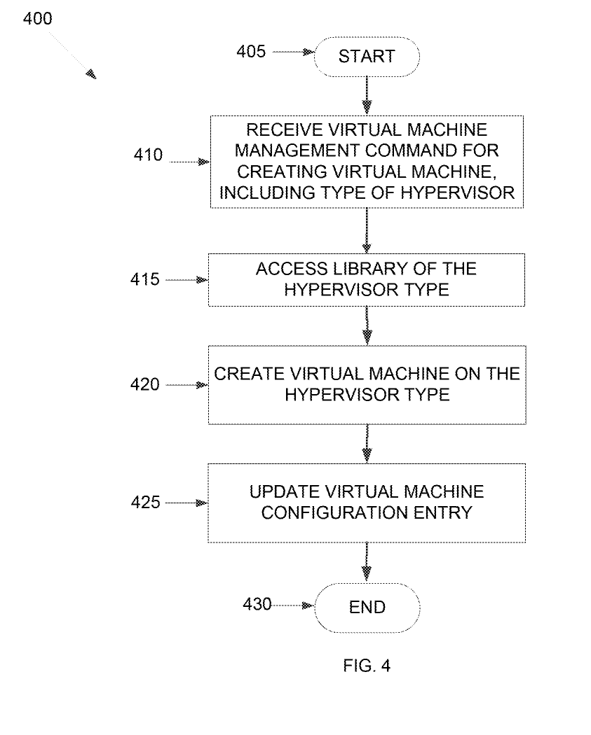

Turning to FIG. 4, an example flowchart outlining operations of a process 400 for creating a new virtual machine is shown, in accordance with some embodiments of the present disclosure. The process 400 may include additional, fewer, or different operations, depending on the particular embodiment. The process 400 may be implemented by the entity management system (e.g., the entity management system 300). After starting at operation 405, the entity management system receives a user request for virtual machine management at operation 410. The user request may be for creating a virtual machine.

The user request may be received from a user authorized to perform virtual machine management via the user interface (e.g., the user interface 310). For example, the user may make a user request by accessing a web browser on a user computing device. The user may enter a uniform resource locator (“URL”) or internet Protocol (“IP”) address for accessing the API (e.g., the API 335) of the entity management system (e.g., the entity management system 300). The URL or IP address to access the API may be known to the user. In other embodiments, other mechanisms for making user requests may be used. The user request from the user's computing device is transferred to the API via a network (not shown). In some embodiments, the network is the World Wide Web or the Internet. In other embodiments, the network may include one or more of the cellular network, Wi-Fi, Wi-Max, ZigBee, Bluetooth, a proprietary network, Ethernet, Universal Serial Bus (“USB”), Thunderbolt, or any other type of wired or wireless network, or a combination thereof. The network is structured to permit the exchange of data, instructions, messages, or other information between the user computing device and the API.

Upon accessing the API (e.g., the API 335), the user may enter a virtual machine management command to create a virtual machine. As part of the virtual machine management command to create a virtual machine, the virtual machine management command includes a type of the hypervisor (e.g., ESXi, AHV, etc.) on which the virtual machine is to be created. The virtual machine management command may also include other types of information (e.g., related to virtual machine configuration parameters). The virtual machine management command may be transferred from the API via a network and/or proxy server to the hypervisor agnostic system (e.g., the hypervisor agnostic system 305) and particularly to the hypervisor agnostic management system (e.g., the hypervisor agnostic management system 315) of the hypervisor agnostic system. Upon receiving the virtual machine management command to create a virtual machine, at operation 415, the hypervisor agnostic management system accesses either the first hypervisor library (e.g., the first hypervisor library 325) or the second hypervisor library (e.g., the second hypervisor library 330) based upon the hypervisor type specified in the virtual machine management command.

For example, if the first hypervisor library (e.g., the first hypervisor library 325) is for an ESXi type of hypervisor and the second hypervisor library (e.g., the second hypervisor library 330) is for an AHV type of hypervisor, and if the type of hypervisor in the virtual machine management command is to create the virtual machine on an AHV hypervisor, the hypervisor agnostic management system (e.g., the hypervisor agnostic management system 315) uses the second hypervisor library for retrieving the appropriate hypervisor resources and performing an operation for creating the virtual machine. If the hypervisor agnostic management system determines that the type of hypervisor requested in the virtual machine management command is other than the type of hypervisor of the first hypervisor library and the second hypervisor library, the hypervisor agnostic management system may issue a notification (e.g., an error message) to the user device from which the virtual machine management command was originally received.

The notification may indicate to the user that the type of hypervisor requested is not supported, or another designated message may be included in the notification. To send the notification to the user device, the hypervisor agnostic management system (e.g., the hypervisor agnostic management system 315) may send the notification to the API (e.g., the API 335) via the network and/or the proxy server, and the API may transmit the notification to the user interface (e.g., the user interface 310) on the user device via the network.

Upon accessing the appropriate library at the operation 415, the hypervisor agnostic management system (e.g., the hypervisor agnostic management system 315) creates the new virtual machine at operation 420. The hypervisor agnostic management system uses the hypervisor resources accessed at the operation 415 to create the virtual machine. For example, if the virtual machine is to be created on an AHV type of hypervisor and if the hypervisor agnostic management system accessed the second hypervisor library (e.g., the second hypervisor library 330) at the operation 415 for the AHV type of hypervisor, at the operation 420, the hypervisor agnostic management system creates the new virtual machine in accordance with the procedures outlined in the hypervisor resources for creating a new virtual machine. In addition, the hypervisor agnostic management system creates the new virtual machine on the type of hypervisor included in the virtual machine management command. Thus, if the virtual machine management command has requested to create the virtual machine on an AHV type of hypervisor, the hypervisor agnostic management system identifies an appropriate node running the AHV type of hypervisor and creates the virtual machine on that node.

In some embodiments, the hypervisor agnostic management system (e.g., the hypervisor agnostic management system 315) creates the virtual machine itself. In other embodiments, the hypervisor agnostic management system transfers the virtual machine management command to create the virtual machine along with the hypervisor resources retrieved at the operation 415 to another component that is responsible for creating virtual machines. That component may then create the virtual machine based upon the hypervisor resources received from the hypervisor agnostic management system. As part of creating the virtual machine, the hypervisor agnostic management system (or the component that created the virtual machine) and/or the hypervisor of the node on which the virtual machine is created also associates a variety of configuration parameters with the newly created virtual machine. For example, the virtual machine may be assigned an identifier. The virtual machine may be associated with a particular number of processing units, a particular amount of memory, a location for storing data of the virtual machine may be designated, etc.

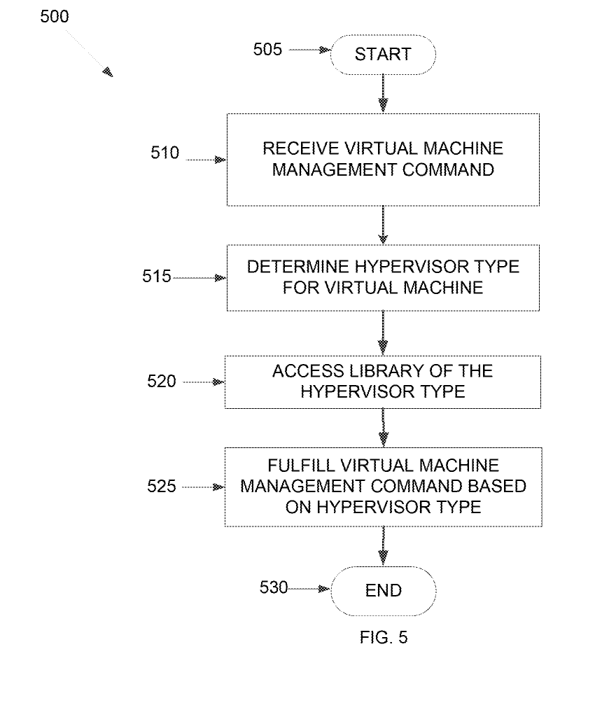

Upon creation of the virtual machine, the hypervisor agnostic management system (e.g., the hypervisor agnostic management system 315), at operation 425, creates a configuration entry for the virtual machine created at the operation 420. The configuration entry is created and stored within the entity configuration database (e.g., the entity configuration database 320). The configuration entry may identify the various configuration parameters of the virtual machine. For example, the configuration entry may identify the name of the virtual machine, the identifier associated with the virtual machine, the type of hypervisor associated with the virtual machine, a current operating state of the virtual machine, and any other configuration parameter associated with the virtual machine. Once the configuration entry is created for the virtual machine, when subsequent user requests are made to the virtual machine, the hypervisor agnostic management system accesses the configuration entry to determine the hypervisor type of the virtual machine and fulfil the user requests based upon the procedure for that hypervisor type, as discussed in greater detail below in FIG. 5.

In some embodiments, the hypervisor agnostic management system (e.g., the hypervisor agnostic management system 315) creates and stores the configuration entry for the virtual machine in the entity configuration database (e.g., the entity configuration database 320). In other embodiments, the component that created the virtual machine may create and store the configuration entry in the entity configuration database. In yet other embodiments, a component other than the one that created the virtual machine may be designated to create and store the configuration entry in the entity configuration database. Once the virtual machine has been created and the configuration entry of the virtual machine has been stored in the entity configuration database, the process 400 ends at operation 430. The hypervisor agnostic management system may send a notification to the user device from which the virtual machine management command was received notifying the user that the virtual machine has been created.

Turning to FIG. 5, an example flowchart outlining a process 500 for handling certain types of virtual machine management commands (e.g., user requests) is shown, in accordance with some embodiments of the present disclosure. The process 500 may include additional, fewer, or different operations, depending on the particular embodiment. The process 500 may be implemented by the entity management system (e.g., the entity management system 300) and may be used for virtual machine management commands other than virtual machine management commands for creating new virtual machines. After starting at operation 505, the entity management system receives a user request (e.g., virtual machine management command) for virtual machine management at operation 510. The user request may be for, for example, updating an existing virtual machine, deleting an existing virtual machine, or for any other virtual machine management operation other than creating a new virtual machine.

The user request may be made by a user authorized to perform virtual machine management. As discussed above, the authorized user may access the API (e.g., the API 335) and transfer the virtual machine management command via the API to the hypervisor agnostic management system (e.g., the hypervisor agnostic management system 315). As part of the virtual machine management command, the user at least identifies the virtual machine to which the virtual machine management command is to be applied. For example, the virtual machine management command may include the identifier associated with that virtual machine. As briefly indicated above, each virtual machine in a cluster is associated with an identifier that uniquely identifies a virtual machine and distinguishes that virtual machine from other virtual machines in that cluster. In some embodiments, the identifier is a universally unique identifier (“UUID”), also referred to as a globally unique identifier (“GUID”). The UUID or GUID is a 128-bit number that may be associated with each of the virtual machines. In other embodiments, the UUID or GUID may be of another bit length and/or other types of identifiers may be used.

The virtual machine management command, thus, includes the identifier of the virtual machine to which the virtual machine management command is to be applied. In other embodiments, the virtual machine management command may include other information as well such as the type of virtual machine management operation (e.g., information to be updated). The user need not be aware of the hypervisor type associated with the virtual machine on which the virtual machine management operation is to be performed. The user only needs to know the identifier of the virtual machine on which the virtual machine management operation is to be performed.

Upon receiving the virtual machine management command, at operation 515, the hypervisor agnostic management system (e.g., the hypervisor agnostic management system 315) determines the type of hypervisor associated with the virtual machine to which the virtual machine management command is to be applied. Specifically, the hypervisor agnostic management system (e.g., the hypervisor agnostic management system 315) retrieves the identifier of the virtual machine included in the virtual machine management command and uses that identifier to access the configuration entry of that virtual machine in the entity configuration database (e.g., the entity configuration database 320). From the configuration entry of the virtual machine, the hypervisor agnostic management system identifies the type of hypervisor of that virtual machine. At operation 520, the hypervisor agnostic management system then accesses the hypervisor library (e.g., the first hypervisor library 325 or the second hypervisor library 330) for the hypervisor type determined at the operation 515 and retrieves the appropriate hypervisor resources of that hypervisor type. For example, if the virtual machine management command is for updating a certain aspect of the virtual machine, the hypervisor agnostic management system retrieves those hypervisor resources from the hypervisor library that pertain to updating that aspect of the virtual machine. Likewise, if the virtual machine management command is to delete the virtual machine, the hypervisor agnostic management system retrieves those hypervisor resources from the hypervisor library that pertain to deleting a virtual machine, and so on.

At operation 525, the hypervisor agnostic management system (e.g., the hypervisor agnostic management system 315) fulfils the virtual machine management command (e.g., performs the update requested in the virtual machine management command, deletes the virtual machine, etc.) using the hypervisor resources obtained from the hypervisor library at the operation 520. In some embodiments, the hypervisor agnostic management system fulfils the virtual machine management command itself. In other embodiments, the hypervisor agnostic management system may transfer the virtual machine management command, along with the hypervisor resources retrieved at the operation 520, to another component, which may then fulfil the request. Upon fulfilling the request, the hypervisor agnostic management system may send a notification back to the user device from which the virtual machine management command was received notifying of the completion of the requested operation. Additionally, the hypervisor agnostic management system (or another component) that is responsible for updating the configuration entries of the virtual machines may update the configuration entry in the entity configuration database (e.g., the entity configuration database 320) if any updates to the configuration entry are needed. The process 500 ends at operation 530.

Thus, the present disclosure provides an easy, convenient, and effective mechanism for managing virtual machines in mixed hypervisor clusters. The user need not be aware of the hypervisor type associated with the virtual machine in performing virtual machine management operations on that virtual machine. The user may simply provide the identifier of the virtual machine on which the virtual machine management operation is to be performed and the entity management system (e.g., the entity management system 300) determines the type of hypervisor associated with that virtual machine, retrieves the proper set of instructions and other resources for performing the requested virtual machine management operation based upon the identified type of hypervisor, and performs the virtual machine management operation (or requests another component to perform the virtual machine management operation).

Although the present disclosure has been discussed with respect to management of virtual machines, in other embodiments, the present disclosure may be applied to the management of any entity within the virtual computing system whose management is dependent upon the type of hypervisor. Further, although the present disclosure has been described with respect to operations that pertain to virtual machine management, in other embodiments, the present disclosure may be used for performing non-management related operations as well. For example, in some embodiments, the present disclosure may also be used for fulfilling input/output requests from the virtual machines.

It is also to be understood that in some embodiments, any of the operations described herein may be implemented at least in part as computer-readable instructions stored on a computer-readable memory. Upon execution of the computer-readable instructions by a processor, the computer-readable instructions may cause a node to perform the operations.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. A method comprising:
receiving, by an entity management system of a virtual computing system, a user request for performing an operation on an entity in a mixed hypervisor cluster of the virtual computing system;
retrieving, by the entity management system, hypervisor resources of a particular hypervisor type associated with the entity, wherein the entity management system is configured to perform the operation on multiple hypervisor types; and
fulfilling, by the entity management system, the user request by performing the operation on the entity using the hypervisor resources of the particular hypervisor type.

2. The method of claim 1, wherein the entity is a virtual machine within the mixed hypervisor cluster of the virtual computing system.

3. The method of claim 2, wherein the user request is a virtual machine management command for performing a management related operation on the virtual machine.

4. The method of claim 2, wherein the user request is for creating the virtual machine.

5. The method of claim 2, wherein the user request is for updating the virtual machine.

6. The method of claim 2, wherein the user request is for deleting the virtual machine.

7. The method of claim 1, further comprising determining, by the entity management system, the particular hypervisor type associated with the entity by accessing a configuration entry of the entity from an entity configuration database.

8. The method of claim 7, wherein the user request includes an identifier of the entity, and wherein the entity management system uses the identifier for accessing the configuration entry of the entity.

9. The method of claim 7, further comprising:
receiving updates, by the entity management system, to the entity; and
updating, by the entity management system, the configuration entry in response to the updates.

10. The method of claim 1, wherein the user request is for creating the entity, and wherein the entity management system receives identification of the particular hypervisor type as part of the user request.

11. The method of claim 1, further comprising accessing, by the entity management system, a hypervisor library for retrieving the hypervisor resources of the particular hypervisor type.

12. The method of claim 1, wherein the entity management system is configured to run on a node of the virtual computing system having a first hypervisor type; and wherein the entity management system is configured to perform the operation using the hypervisor resources of a second hypervisor type.

13. A system comprising:
an entity management system in a mixed hypervisor cluster of a virtual computing system comprising:
a database configured to store a configuration entry of an entity within the mixed hypervisor cluster; and
a processing unit having programmed instructions to:
receive a user request to perform an operation on the entity;
retrieve hypervisor resources of a particular hypervisor type associated with the entity, wherein the entity management system is configured to perform the operation on multiple hypervisor types; and
fulfill the user request by performing the operation on the entity using the hypervisor resources of the particular hypervisor type.

14. The system of claim 13, wherein the entity management system comprises a plurality of hypervisor libraries, and wherein the processing unit is configured to access one of the plurality of hypervisor libraries based on the particular hypervisor type.

15. The system of claim 13, wherein the processing unit further includes programmed instructions is configured to determine the particular hypervisor type from the configuration entry of the database based upon an identifier of the entity included in the user request.

16. The system of claim 13, wherein the particular hypervisor type is identified in the user request.

17. The system of claim 13, wherein the entity management system resides on a node of the virtual computing system, wherein the node runs a first hypervisor type, and wherein the processing unit is configured to perform the operation on a second hypervisor type.

18. (canceled)

19. A non-transitory computer readable media with computer-executable instructions embodied thereon that, when executed by a processor of an entity management system of a virtual computing system, cause the entity management system to perform a process comprising:
receiving a user request for performing an operation on an entity in a mixed hypervisor cluster of the virtual computing system;
retrieving hypervisor resources of a particular hypervisor type associated with the entity, wherein the entity management system is configured to perform the operation on multiple hypervisor types; and
fulfilling the user request by performing the operation on the entity using the hypervisor resources of the particular hypervisor type.

20. The non-transitory computer readable media of claim 19, further comprising determining the particular hypervisor type of the entity from a configuration entry of the entity based upon an identifier included in the user request.

21. The non-transitory computer readable media of claim 19, wherein the particular hypervisor type is identified in the user request.

22. The non-transitory computer readable media of claim 19, wherein the entity is a virtual machine and the operation comprises a virtual machine management operation.

23. A non-transitory computer readable media with computer-executable instructions embodied thereon that, when executed by a processor of an entity management system of a virtual computing system, cause the entity management system to perform a process comprising:
receiving a user request for performing an operation on an entity of the virtual computing system, wherein the entity is part of a cluster having a first hypervisor type and a second hypervisor type different from the first hypervisor type;
determining that the entity is associated with the first hypervisor type; and
performing the operation on the entity in accordance with resources of the first hypervisor type.

24. The non-transitory computer readable media of claim 23, further comprising:
receiving another user request for performing a second operation on another entity of the cluster;
determining that the another entity is associated with the second hypervisor type; and
performing the second operation on the another entity in accordance with resources of the second hypervisor type.

25. The non-transitory computer readable media of claim 23, wherein the entity management system is associated with a first hypervisor library and a second hypervisor library, and wherein the process further comprises accessing the first hypervisor library corresponding to the first hypervisor type to determine the resources of the first hypervisor type.

26. The non-transitory computer readable media of claim 23, wherein the first hypervisor type is identified from the user request.

27. The non-transitory computer readable media of claim 23, wherein the first hypervisor type is determined from an entity database that stores configuration parameters of the entity.
